(19) United States
(12) Patent Application Publication
(10) Pub. No.: US 2025/0224717 A1
(43) Pub. Date: Jul. 10, 2025

(54) INFORMATION PROCESSING APPARATUS AND INFORMATION PROCESSING METHOD

(71) Applicant: KABUSHIKI KAISHA TOSHIBA, Tokyo (JP)

(72) Inventors: Masaharu YAMAMOTO, Yokohama Kanagawa (JP); Ken UENO, Tachikawa Tokyo (JP); Akihiro YAMAGUCHI, Kita Tokyo (JP)

(73) Assignee: KABUSHIKI KAISHA TOSHIBA, Tokyo (JP)

(21) Appl. No.: 19/013,638

(22) Filed: Jan. 8, 2025

(30) Foreign Application Priority Data
Jan. 9, 2024 (JP) 2024-001184

(51) Int. Cl. G05B 23/02

(52) U.S. Cl. CPC G05B 23/0221

(57) ABSTRACT

According to one embodiment, an information processing apparatus includes a processor. The processor is configured to learn a local waveform pattern and a state estimator used to estimate a state of a device, based on multiple elements of first sub-time series data divided from first time series data representing the waveform based on a base cycle of the waveform of a physical quantity changing in accordance with an operation of a device.

### CROSS-REFERENCE TO RELATED APPLICATIONS

This application is based upon and claims the benefit of priority from Japanese Patent Application No. 2024-001184, filed Jan. 9, 2024, the entire contents of which are incorporated herein by reference.

### FIELD

Embodiments described herein relate generally to an information processing apparatus and an information processing method.

### BACKGROUND

In general, it is known that, for example, frequency analysis is performed for time series data (i.e., the physical quantity that represents the waveform in the time series data) measured by devices in order to estimate a normal or abnormal state of the devices (high-frequency device) such as bearings, grinding machines, robot arms, and motors.

However, the frequency analysis can capture the spectrum, but is difficult to detect slight changes in the shape of the waveform itself represented by the time series data, and cannot estimate (detect) the state of the device early from a change in a local shape of the waveform.

### BRIEF DESCRIPTION OF THE DRAWINGS

FIG. 1 is a block diagram showing an example of a functional configuration of an information processing apparatus according to a first embodiment.

FIG. 2 is a view showing an example of a hardware configuration of the information processing apparatus.

FIG. 3 is a table showing an example of a data structure of time series data.

FIG. 4 is a flowchart showing an example of a procedure of the information processing apparatus.

FIG. 5 is a flowchart illustrating processing of a base cycle identification module.

FIG. 6 is a flowchart illustrating processing of a time series data division module.

FIG. 7 is a flowchart illustrating processing of a learning module.

FIG. 8 is a view illustrating multiple elements of sub-time series data divided from the time series data.

FIG. 9 is a block diagram showing an example of a functional configuration of an information processing apparatus according to a second embodiment.

FIG. 10 is a flowchart showing an example of procedure of a state estimation process.

FIG. 11 is a view showing an example of an estimation result display screen.

FIG. 12 is a view illustrating an example of an estimation result in a case of setting a length of a local waveform pattern to be longer than a base cycle.

FIG. 13 is a view illustrating an example of an estimation result in a case of setting a length of a local waveform pattern to a base cycle.

FIG. 14 is a block diagram showing an example of a functional configuration of an information processing apparatus according to a third embodiment.

FIG. 15 is a flowchart showing an example of procedure of a learning process.

FIG. 16 is a flowchart illustrating processing of a segmentation module.

FIG. 17 is a flowchart showing an example of procedure of a state estimation process.

FIG. 18 is a view showing an example of an estimation result display screen.

FIG. 19 is a view showing another example of the estimation result display screen.

FIG. 20 is a table showing an example of a data structure of time series data according to a fourth embodiment.

### DETAILED DESCRIPTION

In general, according to one embodiment, an information processing apparatus includes a processor. The processor is configured to learn a local waveform pattern and a state estimator used to estimate a state of a device, based on multiple elements of first sub-time series data divided from first time series data representing the waveform based on a base cycle of the waveform of a physical quantity changing in accordance with an operation of a device.

Various embodiments will be described hereinafter with reference to the accompanying drawings.

### First Embodiment

First, a first embodiment will be described. An information processing apparatus of the embodiment is used to estimate a state of a device (hereinafter referred to as a target device) in which a characteristic corresponding to a normal or abnormal state appears in the frequency (i.e., a situation of the state appears in a specific cycle). For example, a high-frequency device such as a bearing, a grinder, a robot arm, and a motor is assumed as the target device of the embodiment.

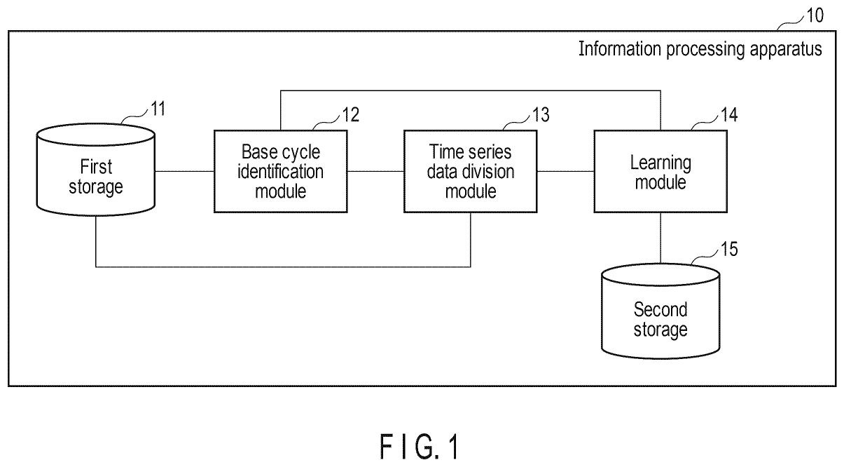

FIG. 1 is a block diagram showing an example of a functional configuration of an information processing apparatus according to the embodiment. As shown in FIG. 1, the information processing apparatus 10 includes a first storage 11, a base cycle identification module 12, a time series data division module 13, a learning module 14, and a second storage 15.

The first storage 11 corresponds to a database which stores time series data representing a waveform of a physical quantity changing in accordance with an operation of a target device. It is assumed that multiple elements of time series data are stored in the first storage 11.

The base cycle identification module 12 acquires the time series data stored in the first storage 11 and identifies the base cycle of the waveform represented by the time series data. The base cycle identified by the base cycle identification module 12 is output to the time series data division module 13 and the learning module 14.

The time series data division module 13 acquires the time series data stored in the first storage 11 and divides the time series data into multiple elements of sub-time series data (divided data) based on the base cycle output from the base cycle identification module 12. The multiple elements of sub-time series data divided from the time series data by the time series data division module 13 are output to the learning module 14.

The learning module 14 learns the local waveform pattern and the state estimator used to estimate the state of the target device, based on the multiple elements of sub-time series data output from the time series data division module 13. Incidentally, the length of the local waveform pattern is determined based on the base cycle output from the base cycle identification module 12, although the detailed description is omitted here.

The second storage 15 corresponds to a database which stores the learning results (i.e., the local waveform pattern and the state estimator) from the learning module 14.

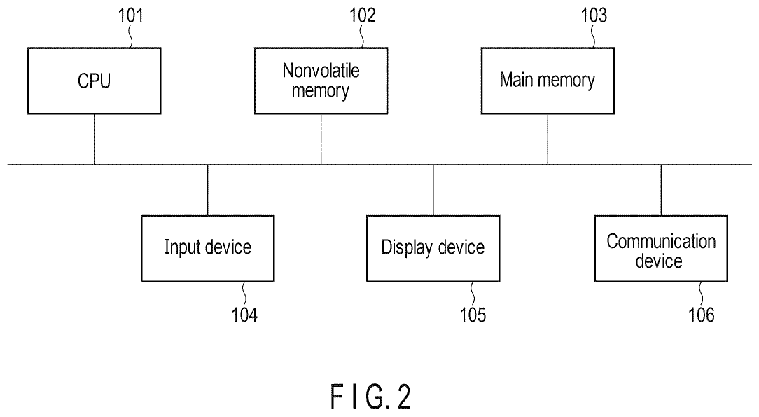

FIG. 2 shows an example of the hardware configuration of the information processing apparatus 10. As shown in FIG. 2, the information processing apparatus 10 comprises a CPU 101, a nonvolatile memory 102, a main memory 103, an input device 104, a display device 105, a communication device 106, and the like.

The CPU 101 is a hardware processor which controls the operation of each component in the information processing apparatus 10. The CPU 101 may be composed of a single processor or multiple processors. The CPU 101 executes various programs loaded from the nonvolatile memory 102 which is a storage device to the main memory 103. The programs executed by the CPU 101 include an operating system (OS), various application programs, and the like.

The input device 104 is a device configured to input various data, and includes, for example, a mouse, a keyboard, and the like. The display device 105 is a device configured to display various data, and includes, for example, a display and the like. The communication device 106 is a device configured to execute, for example, wired or wireless communication with an external device.

Only the nonvolatile memory 102 and the main memory 103 are shown in FIG. 2, but the information processing apparatus 10 may further comprise, for example, other storage devices such as a Hard Disk Drive (HDD) and a Solid State Drive (SSD).

In the embodiment, the first storage 11 and the second storage 15 shown in FIG. 1 are realized by, for example, the nonvolatile memory 102 shown in FIG. 2 or the other storage device.

In addition, in the embodiment, some or all of the base cycle identification module 12, the time series data division module 13, and the learning module 14 shown in FIG. 1 are realized by causing the CPU 101 shown in FIG. 2 to execute a predetermined program, i.e., by software. This program may be downloaded to the information processing apparatus 10 via a network or may be stored in a storage medium and distributed.

It has been described that some or all of the modules 12 to 14 are realized by software, but some or all of modules 12 to 14 may be realized by hardware such as integrated circuits (IC) or by a combination of software and hardware.

Next, the operations of the information processing apparatus 10 according to the embodiment will be described. The information processing apparatus 10 of the embodiment operates as a time series data analysis device which performs learning with the state estimator for estimating the local waveform pattern corresponding to a part (partial waveform) important for capturing the change in the state of the target device in the waveform represented by the time series data stored in the first storage 11, and the state of the target device based on the local waveform pattern.

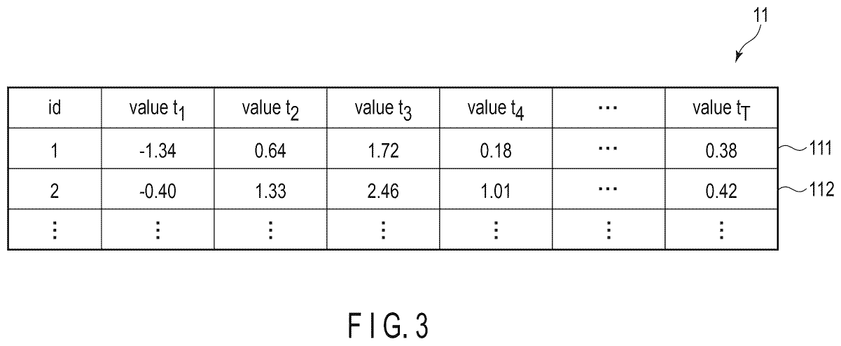

First, an example of the data structure (table in the database) of the time series data stored in the first storage 11 will be described with reference to FIG. 3.

In the example shown in FIG. 3, multiple elements of time series data including time series data 111 and 112 are stored in the first storage 11, and each of the elements of time series data includes values t1 to tT corresponding to id.

The id is the identification information (assigned to the time series data) used to identify the time series data. In this example, t1 to tT correspond to the time, and the values t1 to tT are physical quantities measured at the times t1 to tT while the target device is operating. In other words, it can be said that T time values are recorded for each instance in the first storage 11. Such time series data can represent waveforms by associating the values t1 to tT included in the time series data with the times t1 to tT.

For example, if the target device is a bearing, the values t1 to tT are the acceleration values which represent the vibration caused by the operation of the bearing, and are measured by, for example, an accelerometer or the like attached to the bearing.

In the embodiment, (physical quantities representing the waveforms in) the multiple time series data (the physical quantities that represent the waveform) stored in the first storage 11 are regarded as data measured when the target device under normal conditions (for example, the target device before or immediately after start of operation) is operated.

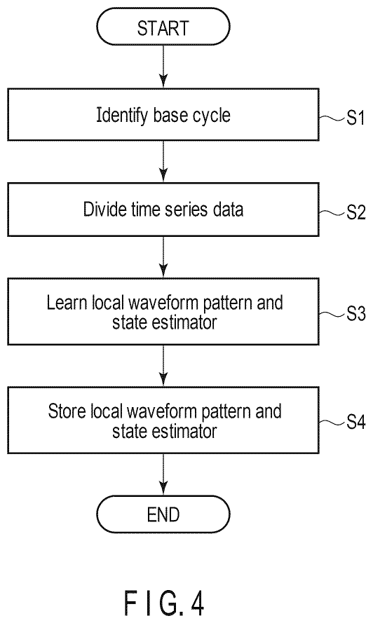

FIG. 4 is a flowchart showing an example of a procedure of the information processing apparatus 10 according to the embodiment.

First, the base cycle identification module 12 identifies the base cycle of the time series data stored in the first storage 11 (step S1).

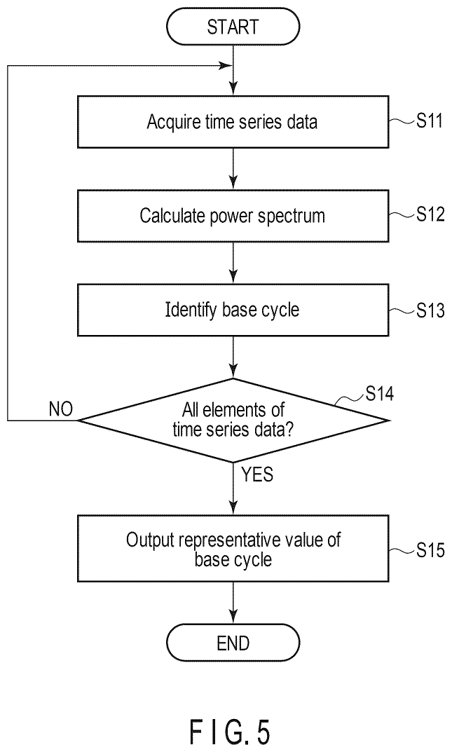

The process in step S1 shown in FIG. 4 (i.e., the process in the base cycle identification module 12) will be described below in detail with reference to a flowchart in FIG. 5.

First, the base cycle identification module 12 acquires one of the multiple elements of time series data stored in the first storage 11 (step S11). In the following descriptions, the time series data acquired in step S11 is referred to as target time series data.

Next, the base cycle identification module 12 calculates a power spectrum by, for example, applying a method such as the periodogram method or Welch method to the target time series data (step S12).

Incidentally, in step S12, when performing the discrete Fourier transform, in order to reduce a leakage error which occurs when the estimated value of the spectrum spreads out from the original peak due to the influence from the apparent discontinuity point on the boundary in a case where a start point and an end point of the target time series data do not match, the power spectrum may be calculated using a window function such as the Hann window or the Hanning window.

The power spectrum calculated in step S12 represents the power (intensity) of each frequency of the target time series data, and the base cycle identification module 12 identifies the cycle (the reciprocal of the frequency) corresponding to the frequency with the highest power in the power spectrum as the base cycle (step S13).

When the process in step S13 is executed, it is determined whether or not the above-described processes in steps S11 to S13 have been executed for all elements of the time series data stored in the first storage 11 (step S14).

If it is determined that the processes are not executed for all elements of the time series data (NO in step S14), the flow returns to step S11 and the processes are repeated. In this case, the time series data for which the processes in steps S11 to S13 have not been executed is acquired in step S11, and the processes in steps S12 and S13 in which the acquired time series data are regarded as the target time series data are executed.

In contrast, it is assumed that the processes have been executed for all the elements of time series data (YES in step S14). In this case, the processes in steps S11 to S13 are repeatedly executed for each of the elements of time series data stored in the first storage 11, and the base cycle is specified (acquired) for each of the elements of time series data. For this reason, the base cycle identification module 12 outputs a representative value of the base cycle identified for each of the elements of time series data (step S15).

The representative value of the base cycle output in step S15 is assumed to be, for example, a value calculated by a weighted average, but may be the other value such as a median or the most frequent value.

According to the above-described processes shown in FIG. 5, even if the elements of time series data are stored (accumulated) in the first storage 11, one base cycle (i.e., a representative value of the base cycle identified for each of the elements of time series data) is output based on the multiple elements of time series data.

Incidentally, in FIG. 5, it has been described that the cycle corresponding to the frequency in which the power is the highest in the power spectrum is identified as the base cycle but, as regards the base cycle, for example, the cycle corresponding to the frequency calculated by weighted average on the multiple frequencies for which the power corresponds to the high level in the power spectrum may be identified as the base cycle.

In other words, the base cycle in the embodiment may be identified by using the frequency (i.e., at least one frequency) for which the power is at the high level in the power spectrum calculated based on the time series data.

In addition, it has been described that a window function is used to calculate the power spectrum, but the window function may not be used for the calculation of the power spectrum.

Furthermore, it has been described in FIG. 5 that the power spectrum is calculated, but the base period may be identified without using the power spectrum. More specifically, for example, autocorrelation coefficients may be calculated based on multiple plots (i.e., values t1 to tT) on the waveform represented by the time series data, and an interval (temporal length) obtained from (times corresponding to) two plots for which the autocorrelation coefficients are the maximum among the multiple plots may be identified as the base period. Incidentally, the base period may also be calculated by a weighted average of the intervals obtained for each of two plots for which the autocorrelation coefficients are at the high level, or the like.

In other words, the base period in the embodiment may be identified by using the plot for which the autocorrelation coefficient is at the high level, in the waveform represented by the time series data.

The descriptions return to FIG. 4, and the time series data division module 13 divides the time series data stored in the first storage 11, based on the base cycle output from the base cycle identification module 12 by executing the above-described processes shown in FIG. 5 (step S2).

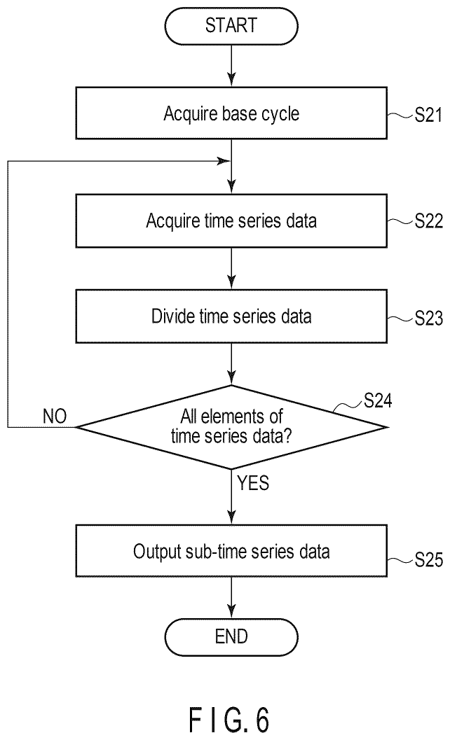

The process in step S2 shown in FIG. 4 (i.e., the process of the time series data division module 13) will be described below in detail with reference to a flowchart in FIG. 6.

First, the time series data division module 13 acquires the base cycle output from the base cycle identification module 12 (step S21).

Next, the time series data division module 13 acquires one of multiple elements of the time series data stored in the first storage 11 (step S22). In the following descriptions, the time series data acquired in step S22 is referred to as the target time series data.

When the process in step S22 is executed, the time series data division module 13 divides the target time series data, based on the base period acquired in step S21 and a predetermined scale factor (step S23).

In this example, when the base period is represented by B and the predetermined scale factor is represented by C, the time series data division module 13 divides the target time series data into the multiple elements of the sub-time series data in which a data length is B×C. According to this, for example, as shown in FIG. 3, if the time series data includes T time values (i.e., the measured number of physical quantities in the time series data is T), the number of sub-time series data (divided data), which corresponds to a fractional part of T/(B×C), is created by executing the process in step S23. In other words, each of the multiple elements of sub-time series data corresponds to the time series data including B×C time values.

Incidentally, the above-described predetermined scale factor is assumed to be, for example, ten times or the like, but may be the other scale factor. In addition, for example, the predetermined scale factor is assumed to be specified by the user using the information processing apparatus 10 via the input device 104 or the like, but may be preset in the information processing apparatus 10 (time series data division module 13).

When the process in step S23 is executed, it is determined whether or not the above-described processes in steps S22 and S23 have been executed for all elements of the time series data stored in the first storage 11 (step S24).

If it is determined that the processes are not executed for all elements of the time series data (NO in step S24), the flow returns to step S22 and the processes are repeated. In this case, the time series data for which the processes in steps S22 and S23 have not been executed is acquired in step S22, and the process in step S23 in which the acquired time series data are regarded as the target time series data is executed.

In contrast, if it is determined that processes have been executed for all elements of the time series data (YES in step S24), the time series data division module 13 outputs the multiple elements of the sub-time series data divided from each of multiple elements of the time series data stored in the first storage 11 (i.e., multiple elements of the sub-time series data created by executing the process in step S23 for each element of the time series data) (step S25).

The descriptions return to FIG. 4, and the learning module 14 learns the local waveform pattern and the state estimator, based on the base cycle output from the base cycle identification module 12 by executing the above-described processes shown in FIG. 5 and multiple elements of the sub-time series data output from the time series data division module 13 by executing the above-described processes shown in FIG. 6 (step S3).

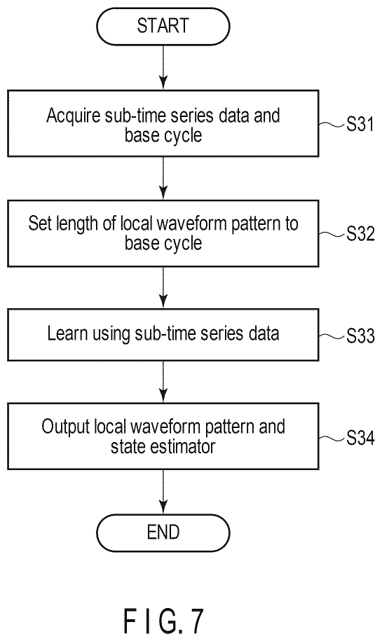

The process in step S3 shown in FIG. 4 (i.e., the process of the learning module 14) will be described below in detail with reference to a flowchart in FIG. 7.

First, the learning Module 14 acquires the base cycle output from the base cycle identification module 12 and the multiple elements of the sub-time series data output from the time series data division module 13 (step S31).

In this case, for example, Shapelets learning is assumed to be used for learning the local waveform patterns and the state estimator in the embodiment. In this case, the local waveform pattern corresponds to a pattern of a representative partial waveform included in the time series data, and is referred to as Shapelets.

In the embodiment, the length of the local waveform pattern is determined based on the base period acquired in step S31. As an example, the learning module 14 sets the length of the local waveform pattern to the base period (step S32).

Next, the learning module 14 learns the local waveform pattern and the state estimator, by using the multiple elements of the sub-time series data acquired in step S31 (step S33). In the embodiment, learning the local waveform pattern and the state estimator is executed by applying One Class Learning Time-series Shapelets (OCLTS) related technology to the multiple elements of the sub-time series data. OCLTS is a time series waveform abnormality detection method which can be learned from only normal cases and which has explanatory power. More specifically, according to OCLTS, it is possible to realize detecting abnormalities by learning local waveform patterns (Shapelets) from the normal waveforms when the waveform deviates from the local waveform (i.e., the waveform is distorted as compared to the local waveform).

Incidentally, learning the local waveform pattern in step S33 means, for example, updating (the shape of) the local waveform pattern by fitting the local waveform pattern to (the waveform represented by) the sub-time series data. Incidentally, since the length (time length) of the local waveform pattern is shorter than the length (time length) of the sub-time series data, the learning module 14 compares the waveform shapes of the local waveform pattern and the sub-time series data while shifting the local waveform pattern in the time axis direction of the sub-time series data, and changes the shape of the local waveform pattern to match the shape of the partial waveform of the sub-time series data, which is most similar to the local waveform pattern.

In addition, if it is assumed that (the physical quantity representing the waveform in) the time series data stored in the first storage 11 as described above is the data measured when the target device under normal conditions is operated, the learning of the state estimator in step S33 means, for example, updating the parameters (for example, weights and the like) of the state estimator so as to output a score (hereinafter referred to as a state score) based on the deviation between (the waveform represented by) the sub-time series data and the local waveform pattern when the sub-time series data is input. Incidentally, in the embodiment, for example, a One Class Support Vector Machine (OCSVM) can be used as the state estimator.

In this example, applying the OCLTS related technology to learn the local waveform pattern and the state estimator has been described but, for example, learning may be executed in which the local waveform pattern is set to the average value of the partial waveform corresponding to one cycle of the sub-time series data or learning the state estimator which captures the change in amplitude of the waveform in one cycle (i.e., outputs a state score based on the change in amplitude of the waveform in the cycle) may be executed.

When the process in step S33 is executed, the learning module 14 outputs the learned local waveform pattern and (the parameters of) the state estimator as the process result of step S33 (step S34).

The descriptions return to FIG. 4, and the local waveform pattern and the state estimator output from the learning module 14 are stored in the second storage 15 by executing the above-described processes shown in FIG. 7 (step S4).

In general, the state estimation of the device may be executed by conducting frequency analysis on time series data. The spectrum can be captured by frequency analysis, but the frequency analysis is not a technology which detects slight changes in the shape of the waveform itself represented by the time series data. It is difficult to capture the changes in which the amplitude increases only for a few cycles at comparatively low frequencies in a gradually degrading device.

More specifically, for example, it is considered that balls of the bearing collide irregularly at comparatively low frequencies and the waveform represented by the time series data thereby collapses. The changes in the waveform cannot be captured as an abnormality sign in such a case, by the above-described frequency analysis.

In contrast, the information processing apparatus 10 of the embodiment learns the local waveform pattern and the state estimator used to estimate the state of the target device, based on the multiple elements of the sub-time series data (first sub-time series data) divided from the time series data (first time series data) representing the waveform based on the base cycle of waveform of the physical quantity changing according to the operation of the target device.

It is thought that according to the local waveform pattern and the state estimator learned in the embodiment, the state of the target device corresponding to the above-described abnormality sign can be estimated based on the time series data measured when the target device is in operation.

More specifically, in the case where the target device in the embodiment is, for example, a gradually degrading bearing, changes in waveform shape which rarely occur in several cycles (i.e., changes in the local shape of the waveform) using the local waveform pattern and the abnormality sign detection model are regarded as an abnormality sign, by learning the local waveform pattern and the abnormality sign detection model (state estimator) using the data acquired at the operation start time for the bearing (i.e., time series data measured when the bearing in a normal state is operated), and the changes in state of the bearing can be detected at an early stage.

Therefore, the information processing apparatus 10 of the embodiment is considered useful for estimating the state of the device (i.e., detecting an abnormality sign).

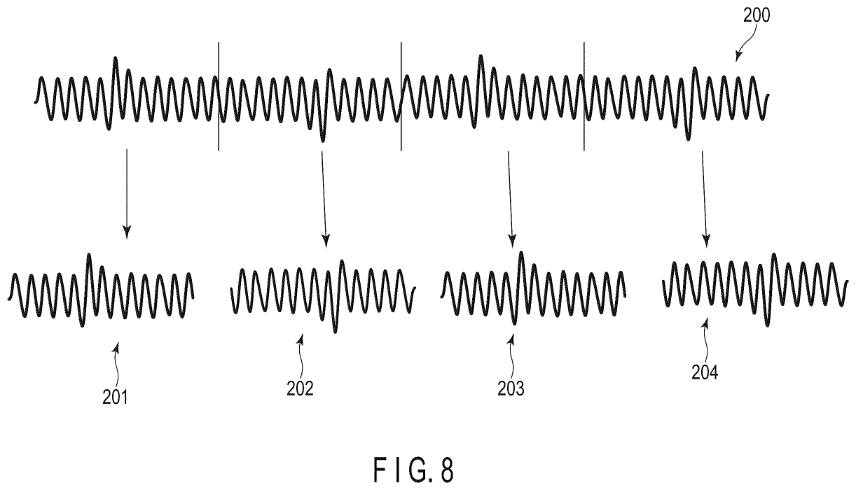

Incidentally, in the embodiment, as shown in FIG. 8, for example, it is possible to increase the number of data (samples) used for learning (i.e., improve the efficiency of learning) by dividing (the waveform represented by) the time series data 200 into (waveforms represented by) the multiple elements of the sub-time series data 201 to 204. In this case, each of the multiple elements of the sub-time series data 201 to 204 can be, for example, a length obtained by multiplying the base cycle by a multiple specified by the user.

In addition, in the embodiment, the shape of the local waveform pattern and the parameters of the state estimator are updated by learning (for example, Shapelets learning) based on the multiple elements of the sub-time series data described above, and the estimation accuracy of the state of the target device using the local waveform pattern and the state estimator can be thereby improved.

In addition, in the embodiment, the length of the local waveform pattern is determined based on the base cycle, but the base cycle may be specified based on the frequency for which the power is at the high level in the power spectrum calculated based on the time series data, or may be specified based on the plot for which the autocorrelation coefficients are at the high level in the waveform represented by the time series data.

Incidentally, it has been described that the information processing apparatus 10 includes the modules 11 to 15 shown in FIG. 1, in the embodiment, but the information processing apparatus 10 may also have a configuration in which some of the modules 11 to 15 shown in FIG. 1 are omitted. More specifically, for example, at least one of the first storage 11 and the second storage 15 may be provided outside the information processing apparatus 10.

In addition, the information processing apparatus 10 of the embodiment is assumed to be realized by a single apparatus, but may be configured such that each of the modules 11 to 15 is provided in a separate apparatus (i.e., may be realized by multiple devices).

### Second Embodiment

Next, a second embodiment will be described. In the embodiment, parts different from the above-described first embodiment will be mainly described.

In the above-described first embodiment, the local waveform pattern and the state estimator are learned (i.e., the information processing apparatus only comprises a learning function), but the embodiment is different from the first embodiment in estimating the state of the target device using the learned local waveform pattern and state estimator (i.e., the information processing apparatus comprises a function of monitoring the target device).

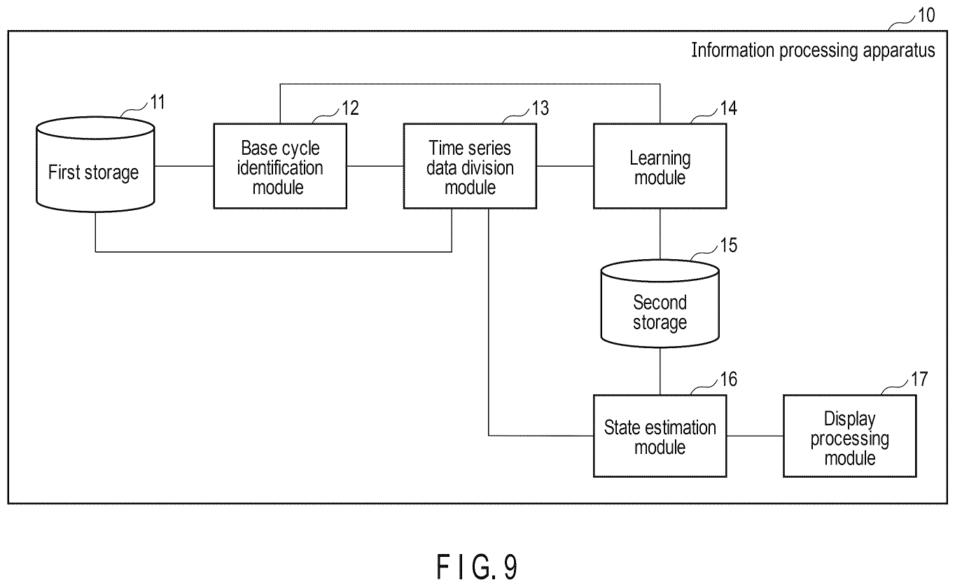

FIG. 9 is a block diagram showing an example of a functional configuration of an information processing apparatus according to the embodiment. Incidentally, in FIG. 9, the same portions as those in FIG. 1 are denoted by the same reference numerals and their detailed explanations are omitted.

As shown in FIG. 9, the information processing apparatus 10 further comprises a state estimation module 16 and a display processing module 17 in addition to the modules 11 to 15 shown in FIG. 1.

The state estimation module 16 acquires time series data and estimates the state of the target device using the time series data and the local waveform pattern and state estimator stored in the second storage 15.

The display processing module 17 displays the state of the target device estimated by the state estimation module 16 (i.e., the estimation result).

The functional configuration of the information processing apparatus 10 according to the embodiment has been described with reference to FIG. 9. However, since the hardware configuration of the information processing apparatus 10 is the same as that of the above-described first embodiment, its detailed descriptions are omitted here.

Incidentally, some or all parts of the state estimation module 16 and the display processing module 17 shown in FIG. 9 may be realized by causing the CPU 101 shown in FIG. 2 to execute predetermined programs, i.e., by software, by hardware, or by configuration formed by combining software and hardware.

In this example, the information processing apparatus 10 of the embodiment executes a process of estimating the state of the target device (hereinafter referred to as “state estimation process”) in addition to the above-described process shown in FIG. 4 (hereinafter referred to as the “learning process”).

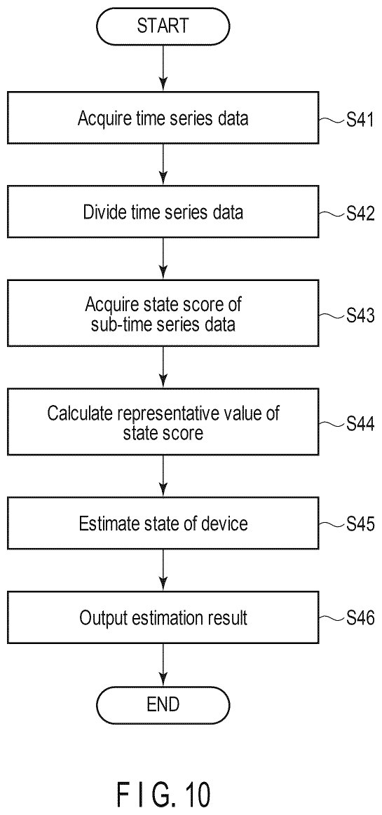

An example of the procedure of the above-described state estimation process will be described below with reference to a flowchart of FIG. 10. Incidentally, it is assumed that the state estimation process is executed after the learning process and that when the state estimation process is executed, the local waveform pattern and the state estimator which have been learned by executing the learning process are stored in the second storage 15.

If the time series data used in the above-described learning process shown in FIG. 4 (i.e., the time series data stored in the first storage 11) is used as the learning data, the state estimation module 16 acquires time series data (hereinafter referred to as state estimation data) different from the learning data (step S41). The state estimation data acquired in step S41 corresponds to, for example, time series data representing the waveform of physical quantity (for example, acceleration or the like) measured while the target device is in operation (i.e., time series data for monitoring the target device in operation), and has the same data structure as the learning data.

Next, the time series data division module 13 divides the state estimation data acquired in step S41 (step S42). Since the process in step S42 is the same as the above-described process in step S2 shown in FIG. 4, its detailed descriptions are omitted here. When the process in step S42 is executed, the state estimation module 16 acquires the multiple elements of sub-time series data output from the time series data division module 13.

Incidentally, the base cycle used in the process in step S42 is assumed to be the base cycle identified by the base cycle identification module 12 in the learning process and to be held in the time series data division module 13 when the learning process is executed.

In addition, it has been described that the process in step S42 is executed by the time series data division module 13, but the process in step S42 may also be executed by the state estimation module 16.

When the processing of step S42 is executed, the state estimation module 16 acquires a state score for each of the elements of sub-time series data by applying the local waveform pattern and state estimator stored in the second storage 15 to the multiple elements of sub-time series data divided from the state estimation data as described above (step S43).

In step S43, the state score output from the state estimator is acquired by inputting the multiple elements of sub-time series data and the local waveform pattern into the state estimator. In this case, in the state estimator, the process of applying the local waveform pattern is applied to each of the multiple elements of sub-time series data and calculating the state score based on the degree of deviation between (the waveform represented by) the sub-time series data and the local waveform pattern is executed.

Incidentally, If the local waveform pattern and the state estimator are learned based on the time series data (i.e., learning data) measured when the target device in a normal state is operated, as described in the above first embodiment, the above-described state score becomes a low value when the target device is in a normal state, and becomes a high value when the target device is in an abnormal state (i.e., deviates from a normal state).

In step S43, the state score is acquired for each of the elements of sub-time series data, and the state estimation module 16 calculates a representative value for the state score acquired for each of the elements of sub-time series data (step S44). Incidentally, the representative value calculated in step S44 includes a statistical quantity such as the average value, standard deviation, or maximum value of the state score for each of the elements of sub-time series data.

Next, the state estimation module 16 estimates the state of the target device, based on the representative value of the state score calculated in step S44 (step S45). In step S45, for example, if the representative value of the state score is greater than or equal to a predetermined value (i.e., a threshold value), it can be estimated that a change occurs in the state of the target device as compared to the time when the learning data is measured (in other words, there is a sign of abnormality in the target device). In other words, the above-described state score based on the deviation from the local waveform pattern can be considered as an abnormality sign score.

Incidentally, in step S45, the process of estimating the state of the target device based on the state score acquired for each of the elements of sub-time series data may be executed, and processes other than those described above may be executed.

When the process in step S45 is executed, the state estimation module 16 outputs the state of the target device estimated in step S45 (hereinafter referred to as an estimation result) (step S46).

Incidentally, the estimation result output from the state estimation module 16 is displayed on, for example, the display device 105 by the display processing module 17.

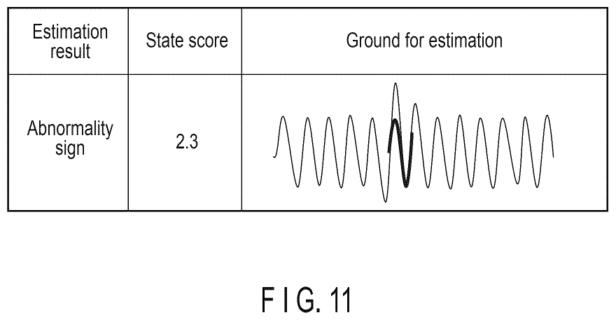

FIG. 11 shows an example of the display screen (hereinafter referred to as an estimation result display screen) when the estimation result is displayed on the display device 105.

As shown in FIG. 11, a sign of abnormality in the target device is displayed as the estimation result on an estimation result display screen. Incidentally, the status score (i.e., the representative value of the status score calculated in step S44) may be displayed on the estimation result display screen.

Furthermore, as shown in FIG. 11, for example, (the waveform represented by) the sub-time series data for which the highest state score has been acquired, and the local waveform pattern are superposed and displayed as a ground for estimation of the state of the target device, on the estimation result display screen. Incidentally, in the example shown in FIG. 11, the sub-time series data is represented by a thin line, and the local waveform pattern is represented by a thick line. The displacement (deviation) between the sub-time series data and the local waveform pattern thus superposed and displayed is understood by the user as the above-described ground for the estimation result.

Incidentally, the estimation result display screen shown in FIG. 11 is just one example, and the estimation result may be displayed in a manner different from that shown in FIG. 11. More specifically, the estimation result, the state score, and the ground for estimation may be processed and displayed on the estimation result display screen. In addition, parts of the estimated result, the state score, and the ground for estimation displayed on the estimation result display screen may be omitted, and information other than the estimation result, the state score, and the ground for estimation may be displayed on the estimation result display screen.

In this example, it has been described that the estimation result output from the state estimation module 16 is displayed on the display device 105. For example, the estimation result may also be transmitted to a server, a terminal device, or the like outside the information processing apparatus 10 via the communication device 106.

As described above, the information processing apparatus 10 of the embodiment divides the state estimation data (i.e., second time series data) into multiple elements of the sub-time series data (i.e., second sub-time series data) based on the base cycle, acquires the state score output from the state estimator by inputting the multiple elements of the sub-time series data and the local waveform pattern to the state estimator (i.e., the state score based on the degree of deviation between the sub-time series data and the local waveform pattern) for each of the elements of the sub-time series data, and estimates the state of the target device based on the acquired state score (i.e., for example, the representative value of the state scores acquired for each of the elements of the sub-time series data).

In the embodiment, with the above-described configuration, for example, the state of the target device in operation can be estimated using the local waveform pattern and the state estimator that have been learned in the above-described first embodiment.

Incidentally, in the embodiment, as described in the above-described first embodiment, the state estimation accuracy of the target device can be improved by setting the length of the local waveform pattern to the base cycle.

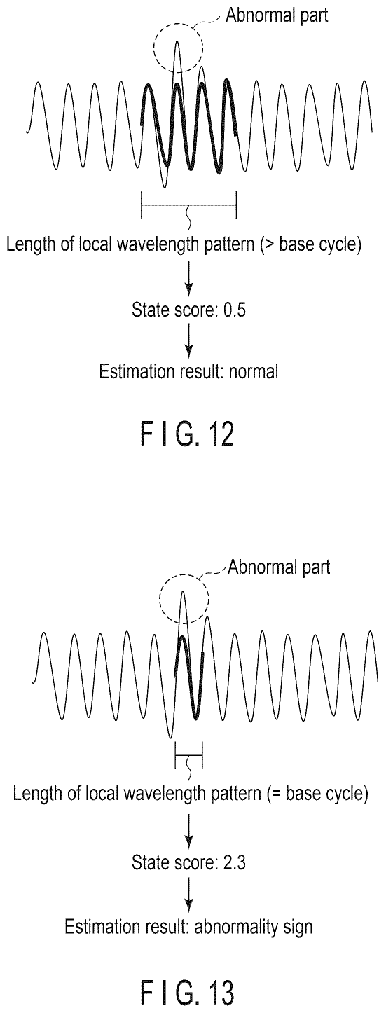

More specifically, FIG. 12 shows a case where the length of the local waveform pattern is set to be longer than the base cycle, indicating that (the representative value of) the state score 0.5 is calculated by using the local waveform pattern and that the target device has been estimated to be in a normal state based on the state score.

In contrast, FIG. 13 shows a case where the length of the local waveform pattern is set to the base cycle, indicating that (the representative value of) the state score 2.3 is calculated by using the local waveform pattern and that the target device has been estimated to have an abnormality sign based on the state score.

In other words, if the length of the local waveform pattern is set to be longer than the base cycle as shown in FIG. 12, an abnormal part in the time series data (sub-time series data) cannot be captured appropriately using the local waveform pattern (i.e., the abnormal part blurs for the local waveform pattern and the abnormality sign cannot be recognized).

In contrast, if the length of the local waveform pattern is set to the base cycle as shown in FIG. 13, the abnormal part in the time series data can be captured as a pin point using the local waveform pattern, and the accuracy of detecting (estimating) the abnormality sign can be improved.

Furthermore, in the embodiment, by estimating the state of the target device from the state score based on each of multiple elements of the sub-time series data divided from the state estimation data, robustness of the state estimation (i.e., evaluation on the state estimation data) can be improved.

In addition, in the embodiment, when the estimated state (estimation result) of the target device is displayed as described above, the sub-time series data and the local waveform pattern are superimposed and displayed. With this configuration, the user can easily recognize (deviation between) the sub-time series data and the local waveform pattern as superimposed and displayed, as the ground for estimation result of the target device.

Incidentally, it has been described that the information processing apparatus 10 executes both the learning process and the state estimation process in the embodiment. However, the information processing apparatus 10 may be configured to execute only the state estimation process (i.e., not to comprise the function of learning, but to comprise the only function of monitoring the target device).

### Third Embodiment

Next, a third embodiment will be described. In the embodiment, parts different from the above-described second embodiment will be mainly described.

The embodiment is different from the above-described second embodiment in segmenting the time series data for each frequency range in the learning process and the state estimation process.

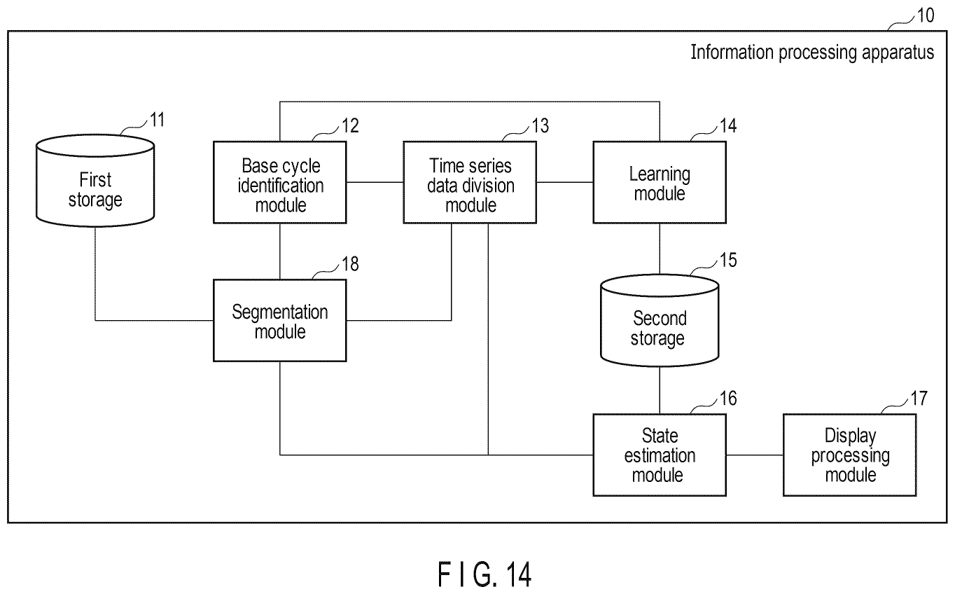

FIG. 14 is a block diagram showing an example of a functional configuration of an information processing apparatus according to the embodiment. Incidentally, in FIG. 14, the same portions as those in FIG. 9 are denoted by the same reference numerals and their detailed explanations are omitted.

As shown in FIG. 14, the information processing apparatus 10 further comprises a segmentation module 18 in addition to the modules 11 to 17 shown in FIG. 9.

The segmentation module 18 segments (divides) the time series data (learning data and state estimation data) in each frequency range. Learning the local waveform pattern and the state estimator in the embodiment is executed for each frequency range in which the learning data is segmented by the segmentation module 18. In addition, the state of the target device in the embodiment is estimated for each frequency range in which the state estimation data is segmented by the segmentation module 18.

The functional configuration of the information processing apparatus 10 according to the embodiment has been described with reference to FIG. 14. However, since the hardware configuration of the information processing apparatus 10 is the same as that of the above-described second embodiment, its detailed descriptions are omitted here.

Incidentally, some or all parts of the segmentation module 18 shown in FIG. 14 may be realized by causing the CPU 101 shown in FIG. 2 to execute predetermined programs, i.e., by software, by hardware, or by configuration formed by combining software and hardware.

The learning process and the state estimation process executed by the information processing apparatus 10 of the embodiment will be described below.

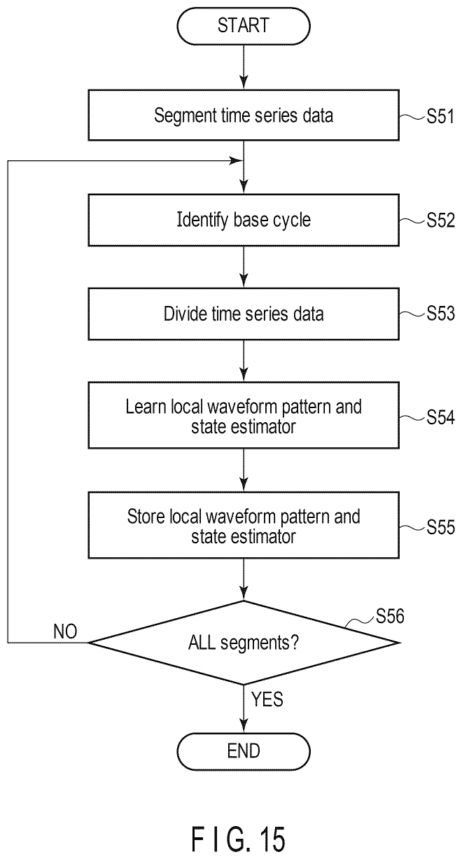

FIG. 15 is a flowchart showing an example of a procedure of the learning process executed in the embodiment.

First, the segmentation module 18 segments the time series data (learning data) stored in the first storage 11 (step S51).

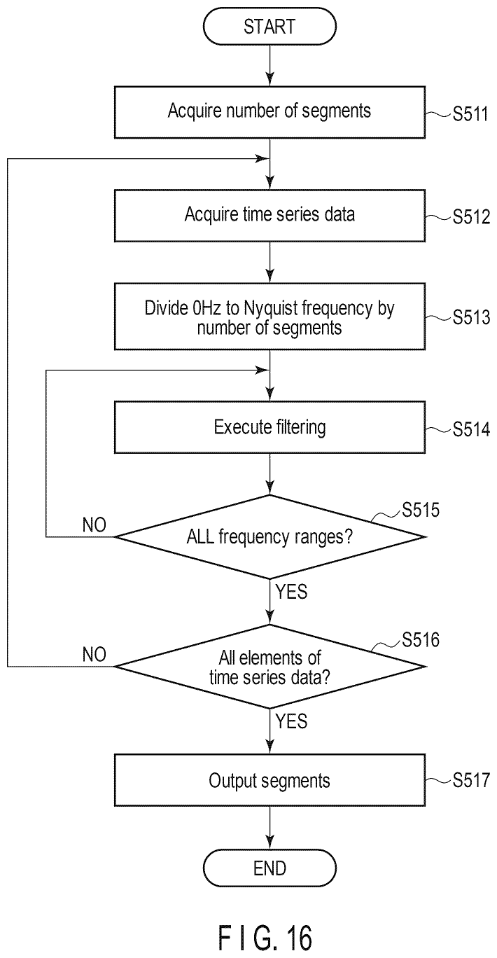

The process in step S51 shown in FIG. 15 (i.e., the process of the segmentation module 18) will be described below in detail with reference to a flowchart in FIG. 16.

First, the segmentation module 18 acquires, for example, the number of segments specified by the user (step S511). Incidentally, it has been described that the number of segments specified by the user is acquired but, in step S511, for example, the number of segments stored in advance in the information processing apparatus 10 (segmentation module 18) may be acquired.

Next, the segmentation module 18 acquires one of the multiple elements of training data (step S512). In the following descriptions, the learning data acquired in step S512 is referred to as target learning data.

Next, the segmentation module 18 obtains the Nyquist frequency of the target learning data, and divides (equally divides) the range from 0 Hz to the Nyquist frequency by the number of segments acquired in step S511 (step S513). Incidentally, the Nyquist frequency corresponds to the maximum frequency that can be detected by Fast Fourier Transform.

The segmentation module 18 executes filtering of the target training data using a band-pass filter in order to extract from the target learning data the time series data of one frequency range (hereinafter referred to as a target frequency range) among multiple elements of the frequency ranges obtained by dividing the range from 0 Hz to the Nyquist frequency in step S513 (step S514). Incidentally, the time series data of the target frequency range obtained by filtering in step S514 are referred to as segments.

If the process in step S514 is executed, it is determined whether or not the process in step S514 has been executed for all frequency ranges obtained by dividing the range from 0 Hz to the Nyquist frequency (step S515).

If it is determined that the processes are not executed for all the frequency ranges (NO in step S515), the flow returns to step S514 and the processes are repeated. In this case, the process in step S514 using the frequency range for which the process in step S514 has not been executed as the target frequency range is executed.

In contrast, if it is determined that process is executed for all frequency ranges (YES in step S515), it is determined whether or not the above-described processes in steps S512 to S515 are executed for all elements of learning data (step S516).

If it is determined that the processes are not executed for all elements of the learning data (NO in step S516), the flow returns to step S512 and the processes are repeated. In this case, the learning data for which the processes in steps S512 to S515 have not been executed is acquired in step S512, and the processes in steps S513 to S515 in which the acquired learning data are regarded as the target learning data are executed.

In contrast, if it is determined that processes have been executed for all the learning data (YES in step S516), the segmentation module 18 outputs the segments (time series data for each frequency range) extracted from each of elements of the learning data by repeatedly executing the process in step S514 (step S517).

It has been described that in the embodiment, by executing the processes described above with reference to FIG. 16, the learning data are segmented for each frequency range (i.e., the time series data for each frequency range are extracted from the learning data). However, the method of segmentation may be different from the method described here.

More specifically, it has been described that the frequency range corresponding to each segment is obtained by dividing the range from 0 Hz to the Nyquist frequency by the number of segments. However, the minimum value and the maximum value of the frequency may be adjusted as appropriate. In addition, as regards the frequency range corresponding to each segment, for example, any range specified by the user may be divided by the number of segments or the frequency range may be directly specified by the user. Furthermore, the frequency ranges corresponding to the respective segments may be superimposed in part.

Furthermore, it has been described that each segment is extracted using a band-pass filter. However, the segment may be acquired by extracting only the specified frequency range and performing an inverse transform after converting the learning data into the frequency domain using a Fourier transform (fast Fourier transform). In addition, the segments may be obtained by reconstructing the learning data using only a part of the decomposition level after expressing the learning data as wavelet coefficients using, for example, continuous wavelet transform or discrete wavelet transform. Incidentally, Discrete wavelet transform includes multi-resolution analysis, wavelet packet, or the like.

In other words, the segmentation of the learning data in the embodiment may be a process of extracting the time series data of a specific frequency range from the learning data, and may be executed using at least one of a band-pass filter, Fourier transform, wavelet transform (continuous wavelet transform or discrete wavelet transform), and the like.

The descriptions return to FIG. 15, and the following processes in steps S52 to S55 are executed for each of (frequency ranges corresponding to) the above-described segments. If the frequency range corresponding to the segment for which the processes in steps S52 to S55 are executed is assumed to be the target frequency range, the processes in steps S52 to S55 correspond to the process in which the state estimation data (time series data) in the above-described processes in steps S1 to S4 shown in FIG. 4 is used as the learning data (i.e., segments) for the target frequency range, and its detailed descriptions are omitted here.

When the process in step S55 is executed, it is determined whether or not the above-described processes in steps S52 to S55 have been executed for all the segments (step S56).

If it is determined that the processes have not been executed for all the segments, the flow returns to step S52 and the processes are repeated.

In contrast, if it is determined that the processes have been executed for all the segments (YES in step S56), the learning process is ended.

According to the above-described learning process, learning the local waveform pattern and the state estimator are executed for each (frequency range corresponding to) segment.

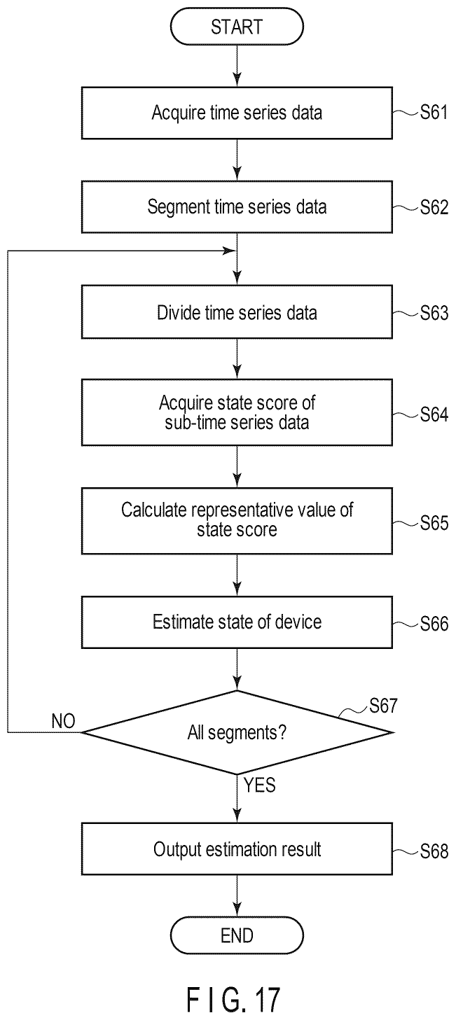

FIG. 17 is a flowchart showing an example of a procedure of the state estimation process executed in the embodiment.

First, a process in step S61 corresponding to the above-described process of step S41 shown in FIG. 10 is executed.

Next, the segmentation module 18 segments the state estimation data acquired in step S61 (step S62). Incidentally, since the process in step S62 corresponds to the process in which the learning data in the above-described process in step S51 shown in FIG. 15, its detailed descriptions are omitted here.

When the process in step S62 is executed, the following processes in steps S63 to S66 are executed for each (frequency range corresponding to) segment extracted from the state estimation data by executing the process in step S62. If the frequency range corresponding to the segment for which the processes in steps S63 to S66 are executed is assumed to be the target frequency range, the processes in steps S63 to S66 correspond to the process in which the state estimation data (time series data) in the above-described processes in steps S42 to S45 shown in FIG. 10 is used as the time series data (i.e., segments) for the target frequency range, and its detailed descriptions are omitted here.

When the process in step S66 is executed, it is determined whether or not the above-described processes in steps S63 to S66 have been executed for all the segments (step S67).

If it is determined that the processes are not executed for all the segments (NO in step S67), the flow returns to step S63 and the processes are repeated.

In contrast, if it is determined that the processes have been executed for all the segments (YES in step S67), the state estimation module 16 outputs the state of the target device estimated for each segment in step S66 (i.e., the estimation result in each frequency range corresponding to the segment) (step S68).

Incidentally, the estimation result for each frequency range, which corresponds to the segment output from the state estimation module 16, is displayed on, for example, the display device 105 by the display processing module 17.

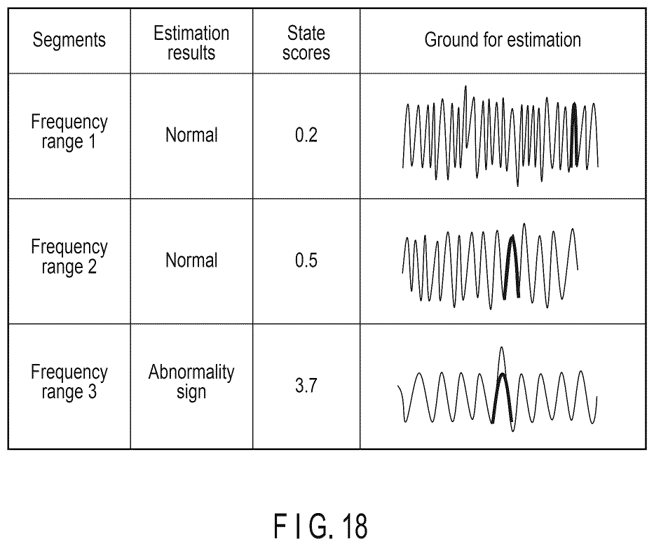

FIG. 18 shows an example of the estimation result display screen in the embodiment. As shown in FIG. 18, the estimated result display screen displays the estimation result, state score, and estimation basis are displayed in association with each of the frequency ranges corresponding to the segments, on the estimation result display screen.

Incidentally, in the example shown in FIG. 18, the estimation result displayed on the estimation result display screen corresponding to frequency range 1 is the state of the target device estimated based on the time series data of frequency range 1 extracted from the state estimation data by segmenting the state estimation data. In addition, in the example shown in FIG. 18, the state score displayed on the estimation result display screen corresponding to frequency range 1 is the representative value of the state score calculated based on the time series data of frequency range 1 extracted from the state estimation data by segmenting the state estimation data. Furthermore, in the example shown in FIG. 18, the sub-time series data for which the highest state score has been acquired when the state of the target device is estimated based on the time series data of frequency range 1 extracted from the state estimation data by segmenting the state estimation data (i.e., the sub-time series data divided from the time series data of the frequency range 1), and the local waveform pattern learned based on the time series data of frequency range 1 are superimposed and displayed as the ground for estimation, in association with frequency range 1, on the estimation result display screen.

In this example, (the segment corresponding to) the frequency range 1 has been described. However, the estimation result, the state score, and the ground for estimation are also displayed for frequency ranges 2 and 3 other than frequency range 1, on the estimation result display screen shown in FIG. 18.

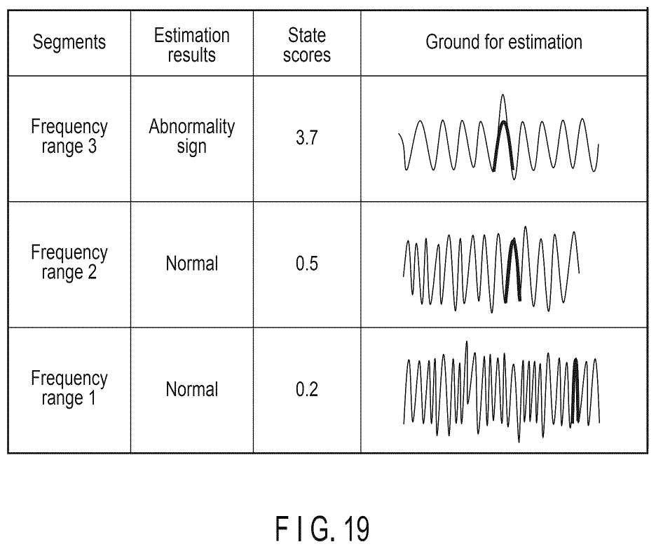

Incidentally, in the example shown in FIG. 18, the estimation result, the state score, and the ground for estimation are displayed in order of frequency ranges 1 to 3 on the estimation result display screen. As shown in FIG. 19, however, the estimation result in which the state score is large may be displayed preferentially, on the estimation result display screen.

As described above, in the embodiment, the learning data (first time series data) are segmented for each frequency, the state estimation data (second time series data) are segmented for each frequency, learning the local waveform pattern and the state estimator is executed for each frequency range in which the learning data is segmented, and the state of the target device is estimated for each frequency range in which the state estimation data is segmented.

In the embodiment, with such a configuration, it is possible to extract the required frequency range and estimate the state of the target device by limiting the frequency range of the time series data even if various frequency ranges (frequency components) are included in the time series data.

More specifically, Shapelets learning of learning the local waveform pattern from the time series data (normal data) measured when the target device in a normal state is operated, and detecting abnormalities based on changes in the waveform shape, using the local waveform pattern is often applied to (the waveforms of) the devices that operate comparatively stably. However, the embodiment can also be applied easily to devices in which waveform changes only appear in certain frequency ranges.

Incidentally, in the embodiment, it has been described that multiple segments are extracted from the time series data by segmentation and that the state of the target device is estimated independently based on each of the segments. However, at least one segment may be extracted from the time series data.

In addition, for example, the segmentation of the time series data in the embodiment can be achieved by one of a process of applying a band-pass filter for each frequency specified by the user to the time series data, a process of converting the time series data to the frequency domain using Fourier transform and then executing inverse transform for a part of the frequency range, and a process of converting the time series data into wavelet coefficients using continuous wavelet transform or discrete wavelet transform and then executing inverse transform for several decomposition levels.

Furthermore, in the embodiment, for example, by displaying the state of the target device estimated for each frequency band in order of the state score, the user can easily recognize the frequency range which expresses changes in the state of the target device (i.e., where an abnormality sign appears).

Incidentally, in the embodiment, since it is possible to recognize (specify) the frequency range in which the sign of abnormality in the target device appears, only the time series data of the recognized frequency range can be used (extracted), for example, when estimating the state of a device of the same type as the target device.

### Fourth Embodiment

Next, a fourth embodiment will be described. In the embodiment, parts different from the above-described first embodiment will be mainly described.

In the above first embodiment, it has been described that the learning process is executed using (the physical quantity representing the waveform in) the time series data measured when the target device in a normal state is operated. However, the embodiment is different from the first embodiment in executing the learning process using the time series data measured when the target device is operated under multiple conditions.

Incidentally, since the functional configuration and the hardware configuration of the information processing apparatus in the embodiment are the same as those of the first embodiment described above, their detailed descriptions are omitted here and the configurations will be described as appropriately with reference to FIG. 1 and the like.

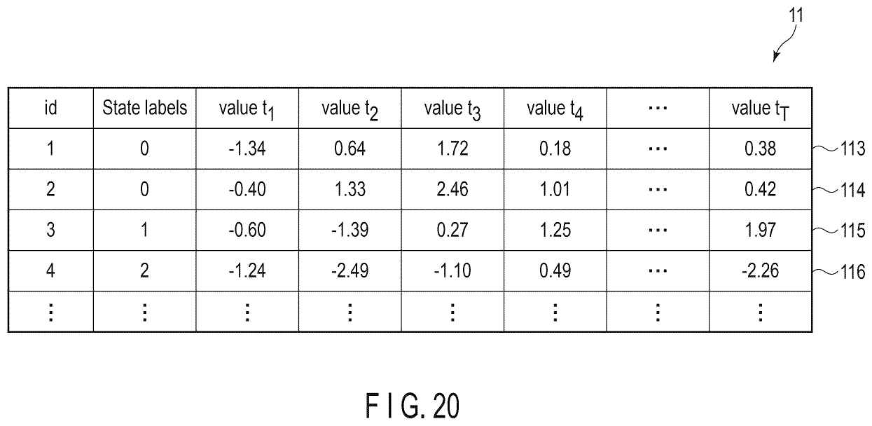

FIG. 20 shows an example of a data structure of the time series data (learning data) stored in the first storage 11 in the embodiment.

In the example shown in FIG. 20, multiple elements of time series data including time series data 113 to 116, are stored in the first storage 11, and each of the time series data includes a state label and values t1 to tT in association with id. Incidentally, since the values id and t1 to tT have been described in the first embodiment (FIG. 3), their detailed descriptions are omitted here.

In the embodiment, the time series data (values of t1 to tT) are measured when the target device is operated, and the state label represents the state (class) of the target device when the time series data are measured. The state label includes, for example, “0” representing a normal state, “1” representing a state of abnormality A, “2” representing a state of abnormality B, and the like. Incidentally, abnormality B is assumed to be a different type of abnormality from abnormality A.

The learning process in the embodiment has been generally described with reference to FIG. 4, and learning the local waveform pattern and the state estimator (supervised learning) is executed based on the state labels included in the above-described time series data.

More specifically, in step S3 shown in FIG. 4, learning is executed to update (the shape of) the local waveform pattern (i.e., by fitting the local waveform pattern to the sub-time series data (i.e., the sub-time series data divided from the time series data including the state label) for each state label. In addition, the local waveform pattern and the state estimator may be simultaneously learned using all the state labels to improve the classification performance.

In addition, in step S3 shown in FIG. 4, learning is executed to update the parameters of the state estimator so as to output the state score based on the deviation between the local waveform pattern and (the waveform represented by) the sub-time series data when the sub-time series data (i.e., the sub-time series data divided from the time series data including the state label) are input, for each state label.

The state estimator that has been learned in the embodiment can output a state score for each state of the target device when, for example, the sub-time series data divided from the state estimation data are input. In the embodiment, multiple states (for example, normal, sign of abnormality A, sign of abnormality B, or the like) of the target device can be estimated based on the state score for each state output from the state estimator.

Incidentally, in the embodiment, for example, methods such as Learning Time-series Shapelets and Region of Interest, may be applied.

In addition, it has been described that the time series data stored in the first storage 11 of the mainly described first embodiment includes the state labels (i.e., is applied to the first embodiment), in the embodiment. However, the embodiment may also be applied to the second or third embodiment. Incidentally, the state labels are included in the learning data for learning purposes, but not included in the state estimation data.

According to at least one of the embodiments described above, an information processing apparatus, an information processing method, and a program that are used to estimate the state of a device can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

With regard to the above-described embodiment, the following supplementary notes will be further disclosed.

(1)

An information processing apparatus including a processor configured to:
learn a local waveform pattern and a state estimator used to estimate a state of a device, based on multiple elements of first sub-time series data divided from first time series data representing the waveform based on a base cycle of the waveform of a physical quantity changing in accordance with an operation of a device.
   (2)

The information processing apparatus of (1), wherein
learning the local waveform pattern and the state estimator includes updating a shape of the local waveform pattern and a parameter of the state estimator.
   (3)

The information processing apparatus of (1) or (2), wherein
learning the local waveform pattern and the state estimator is executed using Shapelets learning.
   (4)

The information processing apparatus of one of (1) to (3), wherein
a length of the local waveform pattern is determined based on the base cycle.
   (5)

The information processing apparatus of one of (1) to (4), wherein
the base cycle is specified based on the frequency for which power is at a high level, in a power spectrum calculated based on the first time series data.
   (6)

The information processing apparatus of one of (1) to (4), wherein
the base cycle is specified based on a plot for which an autocorrelation coefficient is at a high level, among multiple plots on a waveform represented by the first time series data.
   (7)

The information processing apparatus of one of (1) to (6), wherein
each of the multiple elements of the first sub-time series data is a length obtained by multiplying the base cycle by a multiple specified by a user.
   (8)

The information processing apparatus of one of (1) to (7), wherein
the processor is configured to:
   divide second time series data different from the first time series data into multiple elements of second sub-time series data, based on the base cycle;
   acquire, for each of the elements of the second sub-time series data, a score based on a deviation between the second sub-time series data and the local waveform pattern, the score being output from the state estimator by inputting the multiple elements of the second sub-time series data and the local waveform pattern; and
   estimate a state of the device, based on the acquired score.
      (9)

The information processing apparatus of (8), wherein
the processor is configured to estimate a state of the device based on a representative value of the score acquired for each of the elements of the second sub-time series data.
   (10)

The information processing apparatus of (8) or (9), wherein
the processor is configured to:
   display the estimated state of the device; and
   superpose and display the second sub-time series data and the local waveform pattern.
      (11)

The information processing apparatus of one of (8) to (10), wherein
the processor is configured to segment the first time series data for each frequency range and segment the second time series data for each of the frequency ranges,
learning the local waveform pattern and the state estimator is executed for each frequency range in which the first time series data is segmented, and
the state of the device is estimated for each frequency range in which the second time series data is segmented.
   (12)

The information processing apparatus of (11), wherein
the segmentation of the first and second time series data includes one of a process of applying a band-pass filter for each frequency range specified by a user to the first and second time series data, a process of converting the first and second time series data to the frequency range by Fourier transform and then performing inverse transform for a part of the frequency range, and a process of converting the first and second time series data into wavelet coefficients by continuous wavelet transform or discrete wavelet transform and then executing inverse transform for a part of a decomposition level.
   (13)

The information processing apparatus of (11) or (12), wherein
the processor is configured to display the state of the device estimated for each of the frequency ranges in order of the score.
   (14)

The information processing apparatus of one of (1) to (13), wherein
the first time series data includes a label indicating the state of the device when a physical quantity representing a waveform in the first time series data is measured, and
the processor is configured to learn the state estimator so as to output a score capable of estimating multiple states of the device, based on the label included in the first time series data.
   (15)

An information processing method, including:
learning a local waveform pattern and a state estimator used to estimate a state of a device, based on multiple elements of first sub-time series data divided from first time series data representing the waveform based on a base cycle of the waveform of a physical quantity changing in accordance with an operation of a device.
   (16)

The information processing method of (15), wherein
learning the local waveform pattern and the state estimator includes updating a shape of the local waveform pattern and a parameter of the state estimator.
   (17)

The information processing method of (15) or (16), wherein
learning the local waveform pattern and the state estimator is executed using Shapelets learning.
   (18)

The information processing method of one of (15) to (17), wherein
a length of the local waveform pattern is determined based on the base cycle.
   (19)

The information processing method of one of (15) to (18), wherein
the base cycle is specified based on the frequency for which power is at a high level, in a power spectrum calculated based on the first time series data.
   (20)

The information processing method of one of (15) to (18), wherein
the base cycle is specified based on a plot for which an autocorrelation coefficient is at a high level, among multiple plots on a waveform represented by the first time series data.
   (21)

The information processing method of one of (15) to (20), wherein
each of the multiple elements of the first sub-time series data is a length obtained by multiplying the base cycle by a multiple specified by a user.
   (22)

The information processing method of one of (15) to (21), further including:
dividing second time series data different from the first time series data into multiple elements of second sub-time series data, based on the base cycle;
acquiring, for each of the elements of the second sub-time series data, a score based on a deviation between the second sub-time series data and the local waveform pattern, the score being output from the state estimator by inputting the multiple elements of the second sub-time series data and the local waveform pattern; and
estimating a state of the device, based on the acquired score.
   (23)

The information processing method of (22), wherein
the estimating includes estimating the state of the device based on a representative value of the score acquired for each of the elements of the second sub-time series data.
   (24)

The information processing method of (22) or (23), further including:
displaying the estimated state of the device, wherein
the displaying includes superposing and displaying the second sub-time series data and the local waveform pattern.
   (25)

The information processing method of one of (22) to (24), further including:
segmenting the first time series data for each frequency range; and
segmenting the second time series data for each of the frequency ranges, wherein
learning the local waveform pattern and the state estimator is executed for each frequency range in which
the first time series data is segmented, and the state of the device is estimated for each frequency range in which the second time series data is segmented.
   (26)

The information processing method of (25), wherein
the segmentation of the first and second time series data includes one of a process of applying a band-pass filter for each frequency range specified by a user to the first and second time series data, a process of converting the first and second time series data to the frequency range by Fourier transform and then performing inverse transform for a part of the frequency range, and a process of converting the first and second time series data into wavelet coefficients by continuous wavelet transform or discrete wavelet transform and then executing inverse transform for a part of a decomposition level.
   (27)

The information processing method of (25) or (26), further including:
displaying the state of the device estimated for each of the frequency ranges in order of the score.
   (28)

The information processing method of one of (15) to (27), wherein
the first time series data includes a label indicating the state of the device when a physical quantity representing a waveform in the first time series data is measured, and
the learning includes learning the state estimator so as to output a score capable of estimating multiple states of the device, based on a label included in the first time series data.
   (29)

A non-transitory computer-readable storage medium having stored thereon a program which is executed by a computer, the program including instructions capable of causing the computer to execute function of:
learning a local waveform pattern and a state estimator used to estimate a state of the device, based on multiple elements of first sub-time series data divided from first time series data representing the waveform based on a base cycle of the waveform of a physical quantity changing in accordance with an operation of a device.
   (30)

The storage medium of (29), wherein
learning the local waveform pattern and the state estimator includes updating a shape of the local waveform pattern and a parameter of the state estimator.
   (31)

The storage medium of (29) or (30), wherein
learning the local waveform pattern and the state estimator is executed using Shapelets learning.
   (32)

The storage medium of one of (29) to (31), wherein
a length of the local waveform pattern is determined based on the base cycle.
   (33)

The storage medium of one of (29) to (32), wherein
the base cycle is specified based on the frequency for which power is at a high level, in a power spectrum calculated based on the first time series data.
   (34)

The storage medium of one of (29) to (32), wherein
the base cycle is specified based on a plot for which an autocorrelation coefficient is at a high level, among multiple plots on a waveform represented by the first time series data.
   (35)

The storage medium of one of (29) to (34), wherein
each of the multiple elements of the first sub-time series data is a length obtained by multiplying the base cycle by a multiple specified by a user.
   (36)

The storage medium of one of (29) to (35), further causing the computer to:
divide second time series data different from the first time series data into multiple elements of second sub-time series data, based on the base cycle;
acquire, for each of the elements of the second sub-time series data, a score based on a deviation between the second sub-time series data and the local waveform pattern, the score being output from the state estimator by inputting the multiple elements of the second sub-time series data and the local waveform pattern; and
estimate a state of the device, based on the acquired score.
   (37)

The storage medium of (36), wherein
the estimating includes estimating the state of the device based on a representative value of the score acquired for each of the elements of the second sub-time series data.
   (38)

The storage medium of (36) or (37), further causing the computer to display the estimated state of the device, wherein
the displaying includes superposing and displaying the second sub-time series data and the local waveform pattern.
   (39)

The storage medium of one of (36) to (38), further causing the computer to segment the first time series data for each frequency range and to segment the second time series data for each of the frequency ranges, wherein
learning the local waveform pattern and the state estimator is executed for each frequency range in which the first time series data is segmented, and
the state of the device is estimated for each frequency range in which the second time series data is segmented.
   (40)

The storage medium of (39), wherein
the segmentation of the first and second time series data includes one of a process of applying a band-pass filter for each frequency range specified by a user to the first and second time series data, a process of converting the first and second time series data to the frequency range by Fourier transform and then performing inverse transform for a part of the frequency range, and a process of converting the first and second time series data into wavelet coefficients by continuous wavelet transform or discrete wavelet transform and then executing inverse transform for a part of a decomposition level.
   (41)

The storage medium of (39) or (40), further causing the computer to display the estimated state of the device for each frequency range in order of the score.

(42)

The program of one of (29) (41), wherein
the first time series data includes a label indicating the state of the device when a physical quantity representing a waveform in the first time series data is measured, and
the learning includes learning the state estimator so as to output a score capable of estimating multiple states of the device, based on a label included in the first time series data.

What is claimed is:

1. An information processing apparatus comprising a processor configured to:
learn a local waveform pattern and a state estimator used to estimate a state of a device, based on multiple elements of first sub-time series data divided from first time series data representing the waveform based on a base cycle of the waveform of a physical quantity changing in accordance with an operation of a device.

2. The information processing apparatus of claim 1, wherein
learning the local waveform pattern and the state estimator includes updating a shape of the local waveform pattern and a parameter of the state estimator.

3. The information processing apparatus of claim 1, wherein
learning the local waveform pattern and the state estimator is executed using Shapelets learning.

4. The information processing apparatus of claim 1, wherein
a length of the local waveform pattern is determined based on the base cycle.

5. The information processing apparatus of claim 1, wherein
the base cycle is specified based on the frequency for which power is at a high level, in a power spectrum calculated based on the first time series data.

6. The information processing apparatus of claim 1, wherein
the base cycle is specified based on a plot for which an autocorrelation coefficient is at a high level, among multiple plots on a waveform represented by the first time series data.

7. The information processing apparatus of claim 1, wherein
each of the multiple elements of the first sub-time series data is a length obtained by multiplying the base cycle by a multiple specified by a user.

8. The information processing apparatus of claim 1, wherein
the processor is configured to:
divide second time series data different from the first time series data into multiple elements of second sub-time series data, based on the base cycle;
acquire, for each of the elements of the second sub-time series data, a score based on a deviation between the second sub-time series data and the local waveform pattern, the score being output from the state estimator by inputting the multiple elements of the second sub-time series data and the local waveform pattern; and
estimate a state of the device, based on the acquired score.

9. The information processing apparatus of claim 8, wherein
the processor is configured to estimate a state of the device based on a representative value of the score acquired for each of the elements of the second sub-time series data.

10. The information processing apparatus of claim 8, wherein
the processor is configured to:
display the estimated state of the device; and
superpose and display the second sub-time series data and the local waveform pattern.

11. The information processing apparatus of claim 8, wherein
the processor is configured to segment the first time series data for each frequency range and segment the second time series data for each of the frequency ranges,
learning the local waveform pattern and the state estimator is executed for each frequency range in which the first time series data is segmented, and
the state of the device is estimated for each frequency range in which the second time series data is segmented.

12. The information processing apparatus of claim 11, wherein
the segmentation of the first and second time series data includes one of a process of applying a band-pass filter for each frequency range specified by a user to the first and second time series data, a process of converting the first and second time series data to the frequency range by Fourier transform and then performing inverse transform for a part of the frequency range, and a process of converting the first and second time series data into wavelet coefficients by continuous wavelet transform or discrete wavelet transform and then executing inverse transform for a part of a decomposition level.

13. The information processing apparatus of claim 11, wherein
the processor is configured to display the state of the device estimated for each of the frequency ranges in order of the score.

14. The information processing apparatus of claim 1, wherein
the first time series data includes a label indicating the state of the device when a physical quantity representing a waveform in the first time series data is measured, and
the processor is configured to learn the state estimator so as to output a score capable of estimating multiple states of the device, based on the label included in the first time series data.

15. An information processing method, comprising:
learning a local waveform pattern and a state estimator used to estimate a state of a device, based on multiple elements of first sub-time series data divided from first time series data representing the waveform based on a base cycle of the waveform of a physical quantity changing in accordance with an operation of a device.

16. The information processing method of claim 15, wherein
learning the local waveform pattern and the state estimator includes updating a shape of the local waveform pattern and a parameter of the state estimator.

17. The information processing method of claim 15, wherein
learning the local waveform pattern and the state estimator is executed using Shapelets learning.

18. The information processing method of claim 15, wherein
a length of the local waveform pattern is determined based on the base cycle.

19. The information processing method of claim 15, wherein
the base cycle is specified based on the frequency for which power is at a high level, in a power spectrum calculated based on the first time series data.

20. The information processing method of claim 15, wherein
the base cycle is specified based on a plot for which an autocorrelation coefficient is at a high level, among multiple plots on a waveform represented by the first time series data.
